(19) United States
(12) Patent Application Publication
(10) Pub. No.: US 2009/0223689 A1
(43) Pub. Date: Sep. 10, 2009

(54) Percussion Device and Rock Drilling Machine Including Such a Percussion Device

(76) Inventor: Peter Birath, Vintrosa (SE)

Correspondence Address: MARK P. STONE, ATTORNEY AT LAW, 50 BROADWAY, HAWTHORNE, NY, 10532, US

(21) Appl. No.: 12/086,847

(22) PCT Filed: Jan. 26, 2007
(86) PCT No.: PCT/SE2007/000075

§ 371 Date: Jun. 20, 2008

(30) Foreign Application Priority Data
Feb. 20, 2006 (SE) 0600369-3

(51) Int. Cl. B25D 9/26; B25D 9/14

(52) U.S. Cl. 173/13; 173/115; 173/171

(57) ABSTRACT

A percussion device having, inside a machine housing (7), a movable percussive piston (2), the movement of which being controllable through a movable valve body (5), which is arranged to, in dependence of a signal indicating the axial position of the percussive piston, alternately to a pressure source and to a low pressure connect a chamber, in which a driving surface on the piston (2) is located, whereby control channel means (10, 12; 10′, 12′) for transmitting said signal have opening means opening into a cylinder space for receiving the piston (2) for co-operation with a control edge (11,13) on the piston. Adjustment means are arranged for making possible an adjustment of which axial position of the piston said signal is transmitted. The adjustment means includes at least one axially displaceable control means (9, 9′, 9″), which contacts the piston, and which includes a portion (10, 12; 10′, 12′) of the control channel means including the opening means. The invention also concerns a rock drilling machine and a method.

### FIELD OF THE INVENTION

The invention concerns a percussion device according to the preamble of claim 1. The invention also concerns a rock drilling machine including such a percussion device.

### BACKGROUND OF THE INVENTION

EP-0-080 446 (Atlas Copco AB) describes a rock drilling machine wherein the feed force is transmitted from the housing to the drill string or the drill string adapter over a damping device. The damping device yields from the reflected compressive shock waves and the yield is detected and used to control a control pin, which adjusts the stroke length of the piston such that the reflected shock wave energy is minimized.

In particular, the control pin is an adjustment means, which adjusts in which axial position of the piston a pressure signal is transmitted to a to-and-fro movable valve body, wherein means are arranged to control the control pin as a response to the pressure signal, so that the operation of the percussion device is modified in order to minimize reflected shock wave. In an alternative embodiment, the control pin is controlled after analysis of a drilling parameter in connection with the drill string.

The previously known drilling machine works well but gives, however, limited possibilities of controlling the axial positions of the piston.

### AIM AND MOST IMPORTANT FEATURES OF THE INVENTION

It is an aim of the present invention to provide a percussion device of the kind which is defined above, which results in an improvement of the previously known percussion device. In particular it is an aim of the invention to provide a percussion device with increased adjustment possibilities as concerns the movement of the percussive piston.

These aims are obtained according to the invention through the features of the characterising portion of claim 1.

Hereby is achieved that it has been made possible to provide a continuous adjustment of the stroke length of the percussive piston. This is a great advantage, since it gives a possibility of fine-tuning the stroke length in order to more accurately vary the percussive energy delivered from the percussion device as a response to the needs that are present in the particular working situations.

If it is desired to change a striking position of a percussion device, one can move backwards, that is in the direction from the shank adapter, the switching channel for high pressure, which results in longer stroke length and more power in each strike. Given the same pressure, it takes longer time to accelerate the piston when the stroke length is longer, which results in drilling with a lower frequency. In general it could be said that there is a desire to vary the stroke energy of the percussion device based on the variation of the hardness of the rock. In particular it is desired to control the percussion device in this respect after the needs that exist in a particular part of the rock. Through the invention, the percussion device can be controlled more accurately in the direction of optimizing the drilling and reducing shock wave reflexes, which do not contribute to the drilling process.

In general for a drilling process there are indications that drilling with a new drill bit is performed with too high percussive energy. This is because in a new drill bit, only a smaller portion of the working units of the drill bit will come into actual engagement with the rock. After a certain wear, the percussion energy will, however, in due course automatically adjust to the somewhat worn form of the engagement portions of the drill bit, whereby efficiency of the drill process will increase. With continued wear of the drill bit, the efficiency will, however, decrease again because of poorer adaption of the percussive energy to the real shape of the drill bit.

The invention makes it possible to make considerations for this phenomenon and that the percussive energy is controlled to be better adapted to the state of wear of the drill bit. This results in a possibility of achieving increased drilling rates at the same percussion effect, less strain in the drill steel, less reflexes from the rock, which in turn can result in that a smaller damping unit is necessary. Through the invention a drilling machine can be adjusted to varying drill bit wear, rock strength and drill bit size. The drilling machine can hereby be adjusted in advance for some of the parameters, which are known, or be regulated during drilling upon need and sensed parameters.

It is preferred that the control means is a sleeve-shaped element, which surrounds the piston. In particular it is preferred that the control means includes at least two channels which are distributed over the circumference of the control means, since this results in relieving from uneven loads. It is also possible to make the control means as an axially displaceable block shaped element, which lies with a partly cylindrical surface against the surface of a piston.

The control means can be adjusted by means of per se previously known means such as a linear hydraulic motor, a toothed transmission, a screw transmission, a rotational motor or any other suitable means that can perform an axial movement.

According to one aspect of the invention, the control means has first control channel means for the co-operation of the piston in an advance position thereof. According to another aspect of the invention, the displaceable control means has second control channel means for the co-operation with the piston in a position backwards of the piston, as seen from an adapter.

According to a further aspect of the invention, there is provided a first displaceable control means, which includes the first control channel means and a second displaceable control means, which includes the second control channel means. This aspect allows the switching positions of the valve to be controlled independently of each other after desire and need, which gives increased freedom of adjustment.

In a preferred embodiment of the invention, the control means is displaceable as a response to a parameter describing the drilling process, such as for example drilling rate or pressure in a damping chamber, or detected shock wave amplitude as a result of a shock wave measurement.

Further advantages are obtained through further aspects of the invention, which are clear from the following description of an embodiment.

### DESCRIPTION OF DRAWINGS

The invention will now be described at the background of embodiments and with reference to the annexed drawings, wherein:

FIG. 1 shows diagrammatically, in an axial section, a part of a drilling machine including a percussion device according to the invention,

FIG. 2 shows diagrammatically, in an axial section, a part of a percussion device according to the invention in a second embodiment,

FIG. 3 shows a detail in section of another aspect of the invention,

FIG. 4 illustrates a block diagram over a method, wherein the invention is used, and

FIGS. 5a and b shows diagrammatically, in an axial section, a part of a percussion device according to the invention in a further embodiment.

### DESCRIPTION OF EMBODIMENTS

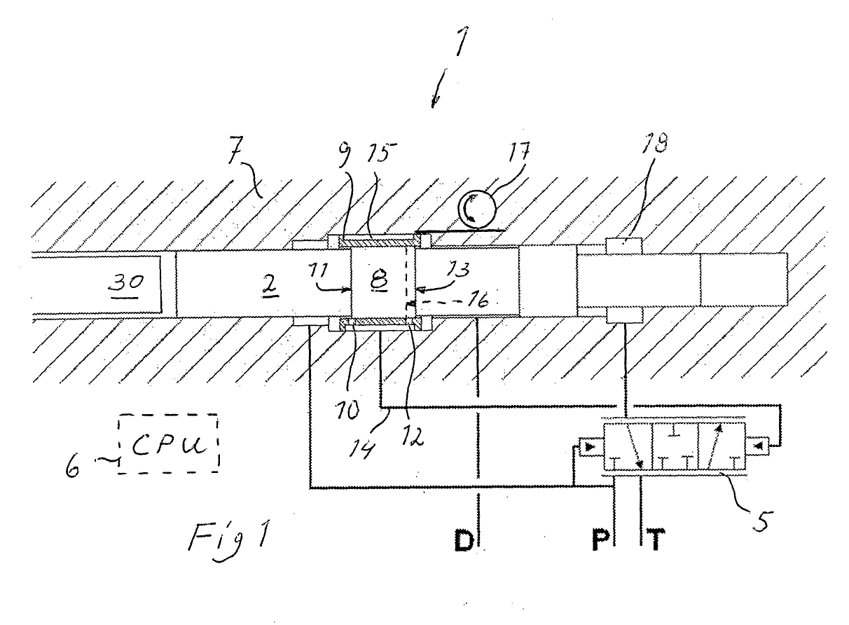

FIG. 1 shows a part of a rock drilling machine 1 including a percussion device with a percussive piston 2. A valve for switching pressure medium for driving the piston is indicated with 5. Further is included a central processing unit 6 and a rotation unit, a damping unit etc., which are not shown in FIG. 1. The piston 2 is moveable to-and-fro inside a machine housing 7.

Inside the machine housing 7 there is in the area of a piston land 8 a, sleeve-shaped control means 9, which surrounds the piston and which has a first control channel means 10, which is arranged to co-operate with a first edge 11 of the piston land 8 with channel opening (openings). The control means 9 includes in this embodiment also second control channel means 12, arranged to co-operate with a second control edge 13 of the piston land 8 by means of a channel opening (openings). A chamber, possible to pressurize, receives in a per se previously known way a driving surface of the piston in the form of a flank of the piston land 8.

The control means 9 are in practice provided with a plurality of control channel portions being control channel means 10 and 12, respectively, distributed over its circumference. In particular the channel portions are evenly distributed over the circumference in order to avoid uneven load because of uneven pressure actuation over the circumference. For communication with a signal conduit 14 which leads to the valve for switching the movement direction of the percussion device, the control means 9 has an outside recess, for example in the form of a surrounding turned cavity 15, which transmits fluid contact between the control channel means 10, 12 and the conduit 14.

In the shown position, the percussion piston has moved from a striking position, where it strikes against a shank 30, from this shank 30. The signal conduit 14 has in this retracted position of the percussion piston just been connected to a high pressure, in particular to the percussive device pressure P over control channel means 10. This results in that the valve 5 will be switched such that the pressure P will act on a piston surface, which is received within the chamber 18 for driving the piston against the striking position.

In the movement resulting from this driving force, the piston 2 is moved to the left as seen in FIG. 1 to an advance position in a position where the control edge 13 is in a position which is indicated with an interrupted line at 16. Hereby a lower pressure will be transmitted to the conduit 14 by it being connected to the drain conduit D for switching the valve back to the position shown in FIG. 1. The upper side of the piston is then connected to tank T so that a low pressure will prevail here. This is per se previously known in conventional percussion devices and will not, for that reason, be described in more detail here.

In order to achieve a possibility of adjusting the positions of the opening means including the openings to the control channel means 10 and 12, the control means 9 is axially displaceable. This can be achieved in many ways such as for example by the control means 9 having a pin, which is inserted into a screw line shaped groove in the machine housing. A rotation of the control means 9 will hereby result in an axial displacement thereof with respect to the machine housing 7.

A second example concerns a toothed wheel 17, which co-operates with a toothed rack being rigidly connected to the control means 9 in order to obtain the axial displacement.

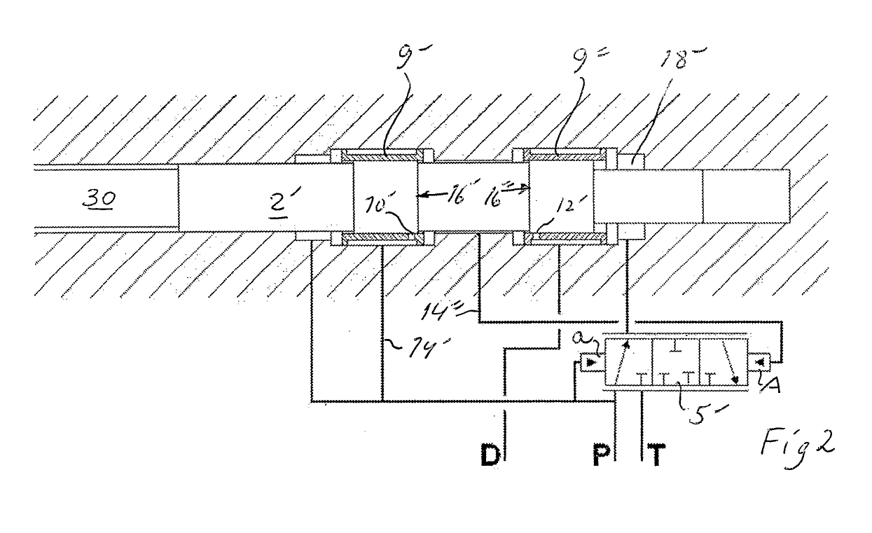

In FIG. 2 is shown a further embodiment, wherein there is a first displaceable control means 9′ for transmitting a high pressure from a conduit 14′ to a conduit 14″ leading to a switching valve 5′ when the control edge 16′ uncovers control channel means 10′ for pressurising, with the pressure P, a switching chamber having an effective pressure area A of a valve body of the valve 5′. This will be the case when the pressure P in the driving chamber 18′ has driven the percussive piston 2′ in the direction against a striking position.

The switching of the valve 5′ from the position shown in FIG. 2 results in draining the driving chamber 18′, where after the piston will be driven back in a direction from the drill shank when it has performed its strike.

Furthermore there is arranged a second control means 9″ for transmitting low pressure to the same conduit 14″, likewise to the pressure area A of said switching valve 5′ when the piston 2′ has retracted so far from the striking position that the control edge 16′ has uncovered the control channel means 12′ and the conduit 14″ has been drained. Thereby the valve will be switched to the position shown in FIG. 2.

The control means are in this case adjustable independently of each other which further increase the flexibility.

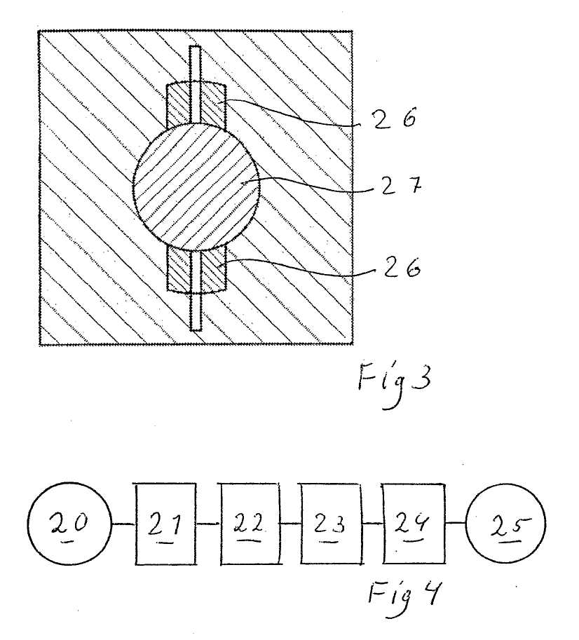

In FIG. 3 is indicated in a diagrammatical cross section through a percussion device of a possible further embodiment of the invention, wherein separate, not ring-shaped control means 26 are arranged, which can be moveable, and which co-operate with a percussive piston 27, in a manner corresponding to the above mentioned sleeve-shaped control means 9, 9′ and 9″. A control means has in this case a contacting surface corresponding to the surface of the piston, being, as seen in a cross section, a smaller portion of the circumference of the piston.

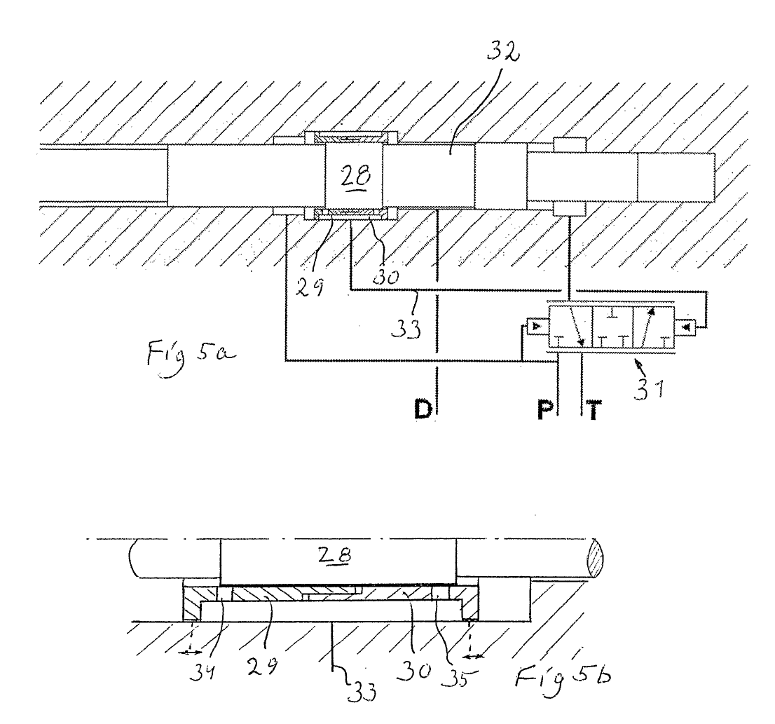

In FIG. 4 is indicated a method sequence for obtaining a strike in a percussion device, wherein:

Position 20 indicates the start of the sequence.

Position 21 indicates performing a strike in a percussion device.

Position 22 indicates obtaining a parameter signal concerning a parameter describing the drilling process, such as the pressure in a damping chamber.

Position 23 indicates analysing the signal obtained in position 22 and producing a signal for adjustment of an axially displaceable control means for modifying the stroke length of the piston.

Position 24 indicates producing a strike in the percussion device with a modified stroke length.

Position 25 indicates the end of the sequence.

FIG. 5a shows an alternative embodiment wherein two independently movable and fixable control means in the form of sleeves 23 and 30 are arranged in co-operation with the piston land 28. In FIG. 5b is shown the construction with the sleeves in a larger scale. The arrangement for displacement and fixation can be of a kind corresponding to what has been discussed for the further embodiments.

The first sleeve 29, the lower or left one in this case, controls with the aid of control channel means 34 in co-operation with the lower control edge of the land which is directed against the drilling tool, over the signal conduit 33 when the valve 31 is to be switched over such that high pressure will come to the driving chamber at the upper side or right side of the piston 32. The second sleeve 30, the upper or right one in this case, controls with the aid of control channel means 35 in co-operation with the upper control edge of the land, which is directed away from the drilling tool, when the valve 31 is to be switched over such that low pressure comes to the upper side or right side of the piston 32 by the conduit 33 being connected to the drain conduit D.

In other words, the lower, left sleeve 29 controls the upper (right) turning position of the piston and the upper, right sleeve controls the lower (left) turning position of the piston. From the drawing it is obvious that when the percussive piston is on its way from a striking position or from the drill shank and there is a low pressure on the upper side of the piston, the control channel means 35 in the right, upper sleeve is closed such that the valve is not drained any more. A short moment later the control channel means 34 in the left, lower sleeve, is opened and the valve is pressurized such that it switches over such that high pressure is transmitted to the upper side of the piston.

By adjusting the position of the left, lower sleeve, high pressure to the valve can be regulated and an adjustment of the position of the right, upper sleeve adjusts when the valve is to be drained.

The invention can be modified further within the scope of the following claims. The control means being used in the percussion device according to the invention can be shaped in a plurality of different ways and can also co-operate with different portions on a percussive piston. The per se previously known switching valve can be constructed differently and be controlled for example with pressurizing both for forward movement and for return movement. Alternatively, return movement can be achieved with the aid of elastic means.

The percussion device can be of different types, with for example permanently applied pressure in the striking direction of the percussive piston and alternating pressurizing for the return stroke. It is also possible to use the invention in a percussion device, wherein the forward movement as well as the return movement are driven with alternating pressurized chambers.

The invention can be used in applications without rotational unit and dampers, for example in so called scaling devices.

1. Percussion device having, inside a machine housing (7), a to-and-fro movable percussive piston (2), the movement of which being controllable through a to-and-fro movable valve body (5), which is arranged to, in dependence of a signal indicating the axial position of the percussive piston, alternately to a pressure source and to a low pressure connect a chamber, in which a driving surface on the piston (2) is located, whereby control channel means (10, 12; 10′, 12′) for transmitting said signal have opening means opening into a cylinder space for receiving the piston (2) for co-operation with a control edge (11, 13) on the piston, and whereby adjustment means are arranged for making possible an adjustment of which axial position of the piston said signal is transmitted, characterized in that said adjustment means includes at least one axially displaceable control means (9, 9′, 9″), which contacts the piston, and which includes a portion (10, 12; 10′, 12′) of the control channel means including the opening means.

2. Percussion device according to claim 1, characterized in that said control means (9) is a sleeve-shaped element which surrounds the piston (2).

3. Percussion device according to claim 2, characterized in that the control means includes at least two channel portions which are distributed over the circumference of the control means (9).

4. Percussion device according to claim 1, characterized in that said control means includes at least one element which has a contact surface corresponding to the surface of the piston, which, as seen in a cross section, is a smaller part of the circumference of the piston.

5. Percussion device according to claim 1, characterized in that the control means is axially adjustable through any of the group: a linear hydraulic motor, a toothed transmission, a screw transmission, a rotational motor.

6. Percussion device according to claim 1, characterized in that the displaceable control means includes first control channel means for co-operation with the piston in an advance position thereof with respect to a drill shank.

7. Percussion device according to claim 1, characterized in that the displaceable control means includes second control channel means for co-operation with the piston in a retracted position thereof with respect to a drill shank.

8. Percussion device according to claim 1, characterized in a first displaceable control means, which includes a first control channel means for co-operation with the piston in an advance position towards the drill shank thereof, and a second displaceable control means, which includes second control channel means for co-operation with the piston in a retracted position thereof with respect to a drill shank.

9. Percussion device according to claim 1, characterized in that said control means is (are) displaceable as a response to a parameter describing the drilling process.

10. Percussion device according to claim 10, characterized in that said parameter is any from the group: drilling rate, pressure in a damping chamber, sensed shock wave amplitude.

11. Rock drilling machine including a percussion device according to claim 1.

12. Method for controlling a percussion device including a percussive piston (2) which is to-and-fro movable inside a machine housing (7), and the movement of which being controllable through a to-and-fro movable valve body (5), which is arranged, in dependence of a signal indicating the axial position of the piston, alternately to connect a chamber to a 44pressure source and to low pressure, wherein a driving surface on the piston (2) is located, whereby control channel means (10, 12; 10′, 12′) for transmitting said signal has opening means opening into a cylinder space receiving the piston (2) for co-operation with a control edge (11, 13) on the piston, and wherein the axial position of the piston where said signal is transmitted is adjusted, characterized in that a control means (9, 9′, 9″), which contacts the piston, and which includes a portion (10, 12; 10′, 12′) of the control channel means including the opening means is displaced axially.

13. Method according to claim 12, characterized in that the control means is axially adjusted through any of the group: a linear hydraulic motor, a toothed transmission, a screw transmission, a rotational motor.

14. Method according to claim 12, characterized in that the first control channel means of the displaceable control means co-operates with the piston in an advance position thereof against a drill shank.

15. Method according to claim 12, characterized in that second control channel means of the displaceable control means co-operate with the piston in a retracted position thereof with respect to a drill shank.

16. Method according to claim 12, characterized in that a first displaceable control means, which includes a first control channel means co-operates with the piston in an advance position thereof against a drill shank and a second displaceable control means, which includes second control channel means, co-operates with the piston in a retracted position thereof from a drill shank.

17. Method according to claim 12, characterized in that said control means is displaced as a response to a parameter describing the drilling process.

18. Method according to claim 17, characterized in that said parameter is any of the group: drilling rate, pressure in a damping chamber, sensed shock wave amplitude.

19. Method according to claim 13, characterized in that the first control channel means of the displaceable control means co-operates with the piston in an advance position thereof against a drill shank.

20. Method according to claim 13, characterized in that second control channel means of the displaceable control means co-operate with the piston in a retracted position thereof with respect to a drill shank.
